(19) United States
(12) Patent Application Publication
(10) Pub. No.: US 2026/0288875 A1
(43) Pub. Date: Sep. 24, 2026

(54) INFORMATION PROCESSING SYSTEM, INFORMATION PROCESSING PROGRAM, AND INFORMATION PROCESSING METHOD

(71) Applicant: MEMORY LAB, INC., Tokyo (JP)

(72) Inventors: Kento HATASE, Tokyo (JP); Yuya SATO, Tokyo (JP); Sien Reeve Ordonez PERALTA, Tokyo (JP)

(21) Appl. No.: 19/477,586

(22) PCT Filed: Apr. 24, 2024
(86) PCT No.: PCT/JP2024/016127

§ 371 Date: Oct. 22, 2025

(30) Foreign Application Priority Data
Apr. 28, 2023 (JP) 2023-075299
Jul. 13, 2023 (JP) 2023-114904
Oct. 2, 2023 (JP) 2023-171702
Oct. 3, 2023 (JP) 2023-172060

(51) Int. Cl. G06F 16/9038; G06F 16/93; G06F 40/40

(52) U.S. Cl. CPC G06F 16/9038; G06F 16/93; G06F 40/40

(57) ABSTRACT

An information processing system is provided. The information processing system includes at least one processor. The processor is configured to perform the following steps. In a first reception step, first information on items desired to be searched by a user that is inputted by the user is received. In an acquisition step, a plurality of keywords recalled from the items are acquired via a large-scale language by using a predetermined prompt including inputted first information. In a first display control step, second information in which the items are organized for each theme of a plurality of documents is displayed on the basis of the plurality of keywords and a database storing the information of the plurality of documents.

### CROSS REFERENCE TO RELATED APPLICATIONS

This application is a 371 U.S. National Phase of International Application No. PCT/JP2024/016127, filed on Apr. 24, 2024, which claims priority to Japanese Patent Application No. 2023-075299, filed on Apr. 28, 2023, Japanese Patent Application No. 2023-114904, filed on Jul. 13, 2023, Japanese Patent Application No. 2023-171702, filed on Oct. 2, 2023, and Japanese Patent Application No. 2023-172060, filed on Oct. 3, 2023. The entire disclosures of the above applications are incorporated herein by reference.

### BACKGROUND

### Technical Field

The present invention relates to an information processing system, an information processing program, and an information processing method.

### Related Art

Japanese Unexamined Patent Application Publication No. 2010-262519 (PTL 1) discloses a method of collecting data for business implementation.

In business development utilizing science and technology, hypothesis building and preliminary research are required. However, an enormous number of papers and patents exist regarding a given science and technology. Additionally, as technologies become increasingly specialized and advanced, it is difficult to efficiently understand papers and patents related to technologies in fields that differ even slightly from one's own specialty.

### SUMMARY

According to one aspect of the present invention, an information processing system is provided. The information processing system includes at least one processor. The processor is configured to execute the steps including:
a first reception step of receiving first information, input by a user, regarding an item that the user wishes to search for;
an acquisition step of acquiring multiple keywords evoked from the item via a large language model using a predetermined prompt including the input first information; and
a first display control step of displaying, based on the multiple keywords and a databse storing information on multiple documents, second information in which the item is organized for each theme of the multiple documents.

According to one aspect of the present invention, a more useful information processing system and the like can be provided.

### BRIEF DESCRIPTION OF THE DRAWINGS

FIG. 1 is a diagram illustrating an example of the system configuration of an information processing system 1000.

FIG. 2 is a diagram illustrating an example of the hardware configuration of a server device 100.

FIG. 3 is a diagram illustrating an example of the hardware configuration of a client device 110.

FIG. 4 is a sequence diagram (part 1) illustrating an example of information processing in the information processing system 1000.

FIG. 5 is a diagram illustrating an example of a screen 500.

FIG. 6 is a sequence diagram (part 2) illustrating an example of information processing in the information processing system 1000.

FIG. 7 is a diagram illustrating an example of a screen 700.

FIG. 8 is a diagram illustrating an example of a screen 800.

### DETAILED DESCRIPTION

Hereinafter, an embodiment of the present invention will be described using the drawings. Various features discussed in the following embodiment can be combined with each other.

In the present specification, the term “unit” may also include, for example, a combination of hardware resources implemented by a circuit in a broad sense, as well as the information processing performed by software that may be specifically implemented by such hardware resources. Additionally, various types of information are handled in the present embodiment, regardless of whether such information is represented by high and low signal levels in a binary bit set consisting of 0s and 1s, by physical values such as signal values, or by quantum superposition, and communication and computation may be executed on a circuit in a broad sense.

Furthermore, the term “circuit” in a broad sense refers to a circuit that is implemented by appropriately combining at least a circuit, circuitry, processor, and memory.

That is, it includes application-specific integrated circuits (ASICs), programmable logic devices (such as simple programmable logic devices (SPLDs), complex programmable logic devices (CPLDs), and field-programmable gate arrays (FPGAs)), and similar devices.

A program for implementing the software described in the embodiment may be provided in a downloadable form from a server device, may be executed on a cloud computer, or may be stored and distributed via a volatile or non-volatile, non-transitory storage medium.

### EMBODIMENT 1

### 1. System Configuration

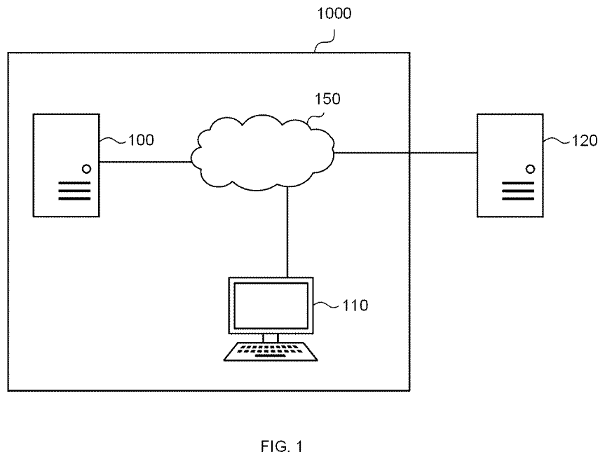

FIG. 1 is a diagram illustrating an example of the system configuration of an information processing system 1000. As illustrated in FIG. 1, the information processing system 1000 includes, as its system configuration, a server device 100 and a client device 110. The server device 100 and the client device 110 are communicatively connected via a network 150. The information processing system 1000 is also communicatively connected to an information processing system 120 via the network 150. Note that the server device 100 may be implemented as a cloud system.

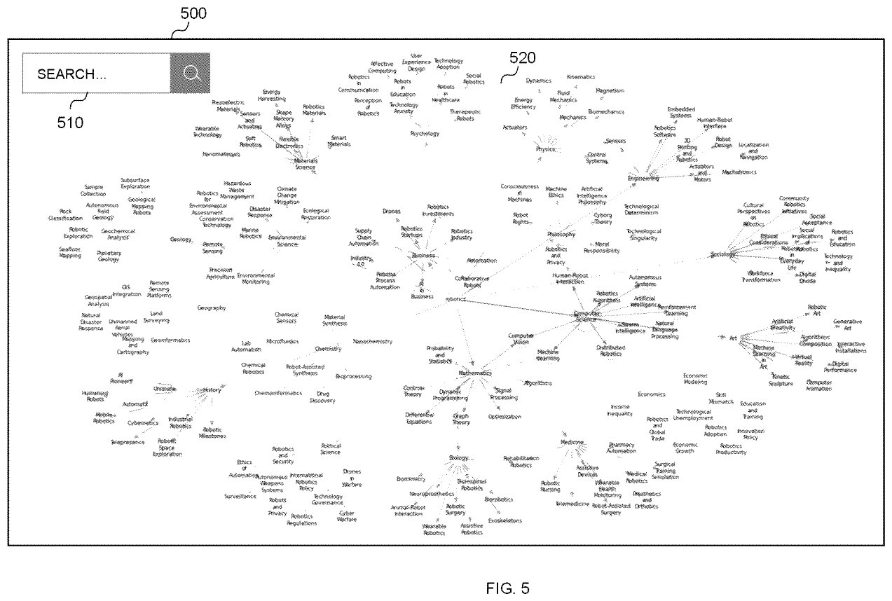

The server device 100 executes processing related to Embodiment 1, including modifications described later. More specifically, the server device 100 controls the client device 110 to display screens as illustrated in FIGS. 5, 7, and 8, which will be described later, in response to requests from the client device 110.

The client device 110 is a terminal used by a user and displays screens as illustrated in FIGS. 5, 7, and 8, which will be described later. In FIG. 1, only one client device 110 is illustrated for the sake of simplicity; however, the information processing system 1000 may include multiple client devices 110. Note that, in the following description, a single client device 110 will be used as an example for the sake of simplicity.

The information processing system 120 is another information processing system, separate from the information processing system 1000, that provides functions of a large language model. A large language model is a type of deep learning model having hundreds of millions to hundreds of billions of parameters. The large language model is trained on a large-scale text corpus and is used to perform natural language understanding tasks. The large language model interprets a sentence provided as a prompt and generates an appropriate response in that context. Examples of large language models include a Generative Pre-trained Transformer (GPT (registered trademark)) and other similar models. For example, the information processing system 120 provides the functions of a large language model as the functions of a cloud service.

In FIG. 1, a PC (Personal Computer) is illustrated as an example of the client device 110; however, the client device 110 is not limited to a PC and may alternatively be a smartphone, tablet computer, or other similar devices. The client device 110 may be any device that, for example, can display information from the server device 100 or allow a user to input an item that the user wishes to search for.

Here, the information processing system described in the claims may be composed of multiple devices or a single device. When the information processing system described in the claims is composed of a single device, an example of such a device is the server device 100. When the information processing system described in the claims is composed of multiple devices, examples of the multiple devices include the server device 100 and the client device 110, or the server device 100 and a cloud system that provides the same or equivalent functions as those of the server device 100.

### 2. Hardware Configuration

### Hardware Configuration of Server Device 100

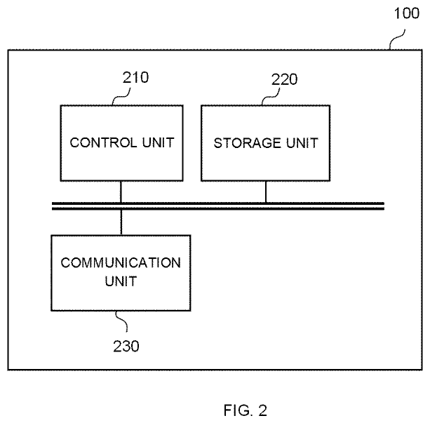

FIG. 2 is a diagram illustrating an example of the hardware configuration of the server device 100. The server device 100 includes, as its hardware configuration, a control unit 210, a storage unit 220, and a communication unit 230. Each component is described in more detail below.

The control unit 210 is a CPU (Central Processing Unit) or the like, and controls the entire server device 100.

The storage unit 220 is any of an HDD (Hard Disk Drive), ROM (Read Only Memory), RAM (Random Access Memory), SSD (Solid State Drive), or any combination thereof, and stores programs as well as data and other similar information used by the control unit 210 when executing processing based on the programs. By executing processing based on the programs stored in the storage unit 220, the control unit 210 implements the functions of the server device 100. The storage unit 220 is an example of a storage medium. Note that, although it is described in the present embodiment that the data used by the control unit 210 when executing processing based on the programs is stored in the storage unit 220, the data may alternatively be stored in the storage unit or the like of another device capable of communicating with the server device 100. That is, the data may be stored in the storage unit of any device, as long as it can be referred to by the control unit 210. A document database is stored in the storage unit 220. Details will be described later.

The communication unit 230 is a NIC (Network Interface Card) or the like, and connects the server device 100 to the network 150, thereby managing communication with other devices.

### Hardware Configuration of Client Device 110

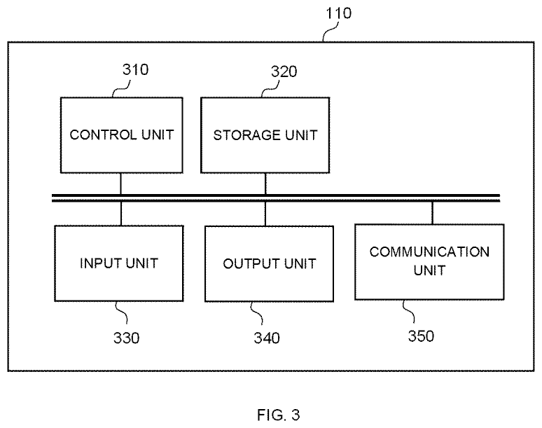

FIG. 3 is a diagram illustrating an example of the hardware configuration of the client device 110. The client device 110 includes, as its hardware configuration, a control unit 310, a storage unit 320, an input unit 330, an output unit 340, and a communication unit 350.

The control unit 310 is a CPU or the like, and controls the entire client device 110.

The storage unit 320 is any of an HDD, ROM, RAM, SSD, or any combination thereof, and stores programs as well as data and other similar information used by the control unit 310 when executing processing based on the programs. By executing processing based on the programs stored in the storage unit 320, the control unit 310 implements the functions of the client device 110. The storage unit 320 is an example of a storage medium.

The input unit 330 includes a keyboard, mouse, and/or the like, and inputs information into the client device 110 based on the user's input operation. The input unit 330 receives an operation input made by the user. The input is transferred as a command signal to the control unit 310, enabling the control unit 310 to perform predetermined control or computation as necessary.

The output unit 340 is a display or the like, and outputs, as a result of processing performed by the control unit 310, information input via the input unit 330, information received from the server device 100 via the communication unit 350, or other similar information.

The communication unit 350 is a NIC or the like, and connects the client device 110 to the network 150, thereby managing communication with other devices.

### 3. Functional Configuration of Server Device 100

The control unit 210 is configured to execute a reception step, an acquisition step, a display control step, a generation step, and an analysis step.

The reception step is a step of receiving a user's input on a search screen. For example, a first reception step is a step of receiving first information, input by a user, regarding an item that the user wishes to search for. A second reception step is a step of receiving a selection for one particular theme from among themes of the documents. Details will be described later.

The acquisition step is a step of acquiring multiple keywords evoked from the item via a large language model using a predetermined prompt including the input first information. Details will be described later.

The display control step is a step of applying control to display visual information, including a screen, an image including a still or moving image, an icon, or a message, on the output unit 340 of the client device 110. The display control step may generate only rendering information for displaying visual information on the output unit 340 of the client device 110. Specifically, a first display control step is a step of displaying, based on the multiple keywords and a database storing information on multiple documents, second information in which the item is organized for each theme of the documents. A second display control step is a step of displaying third information related to the selected particular theme. Details will be described later.

A first generation step is a step of generating a prompt to be input to the large language model. A second generation step is a step of generating second information and third information to be displayed on the client device 110. Details will be described later.

The analysis step is a step of performing analysis based on multiple keywords acquired from the large language model and the database storing information on multiple documents. Details will be described later.

### 4. Flow of Information Processing

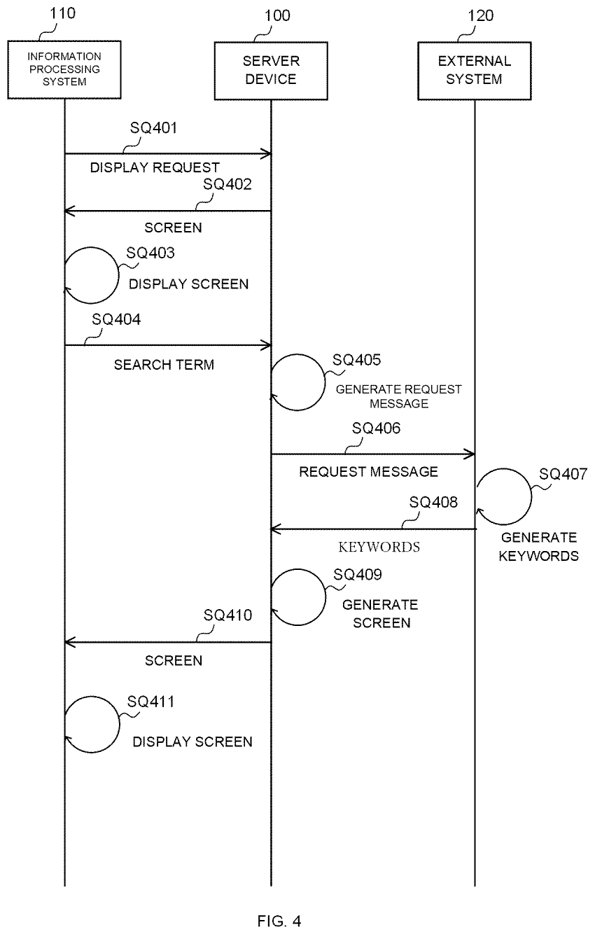

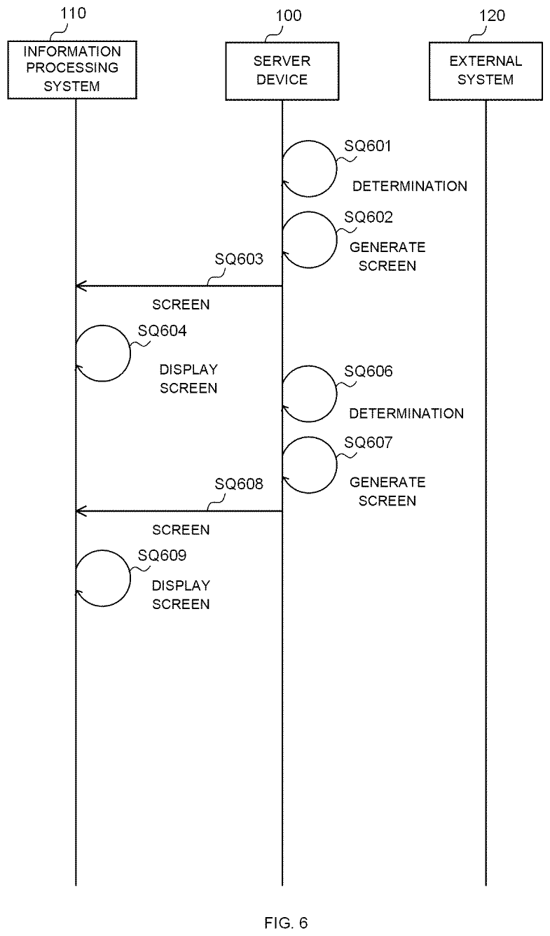

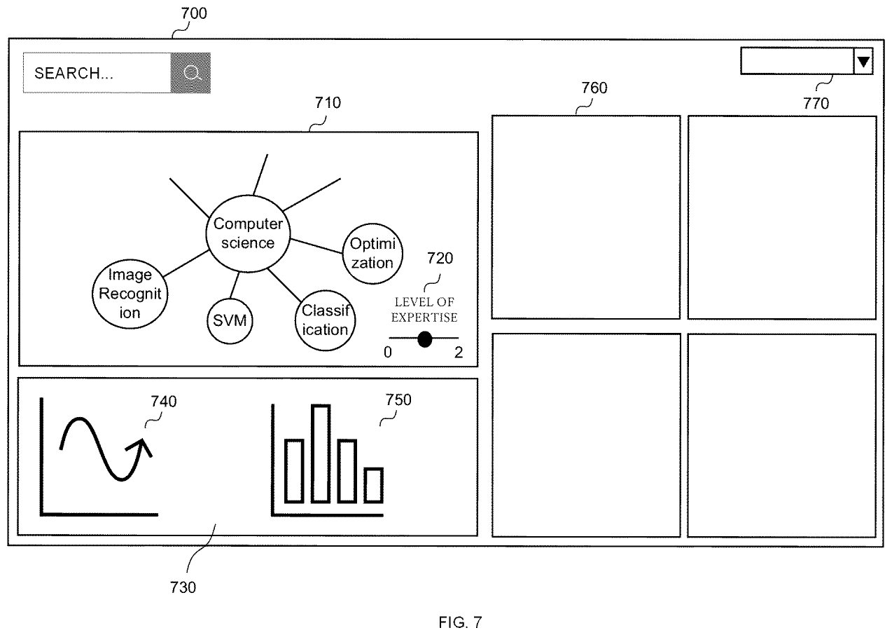

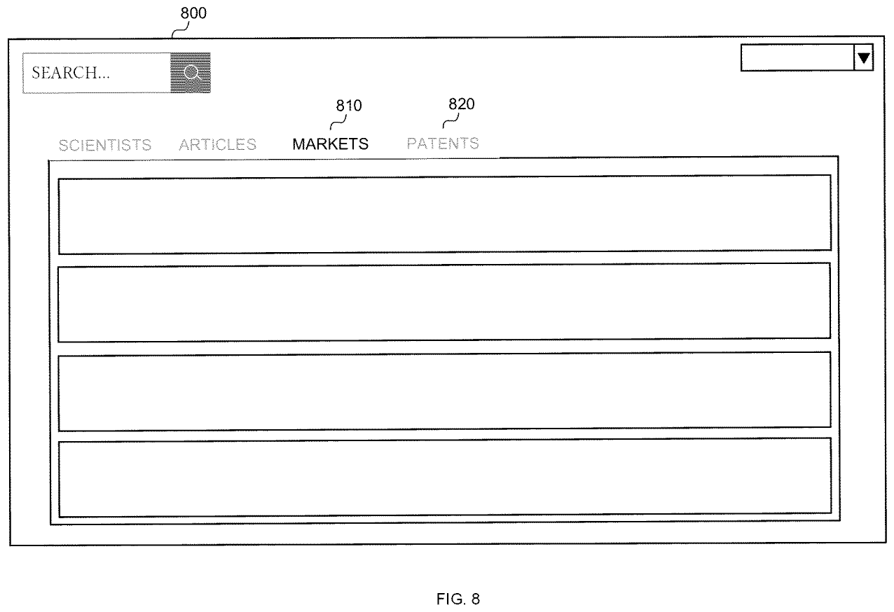

This section describes the information processing method of the information processing system 1000 according to a first embodiment. FIG. 4 is a sequence diagram (part 1) illustrating an example of information processing in the information processing system 1000. FIG. 5 is a diagram illustrating an example of a screen 500. FIG. 6 is a sequence diagram (part 2) illustrating an example of information processing in the information processing system 1000. FIG. 7 is a diagram illustrating an example of a screen 700. FIG. 8 is a diagram illustrating an example of a screen 800.

As discussed below, the information processing system 1000 includes at least one processor. The processor implements the following steps. The program of the present embodiment is a program for executing the steps of the information processing method of the information processing system 1000. Note that the order of the processes may be appropriately changed, multiple processes may be executed simultaneously, and some processes may be omitted.

### 4.1 Overview of Flow (Part 1)

FIG. 4 is a sequence diagram (part 1) illustrating an example of information processing in the information processing system 1000. The user inputs a query regarding an item that the user wishes to search for via a search screen displayed on the client device 110, and the server device 100 executes the processing. Hereinafter, an explanation will be given in accordance with each sequence in this sequence diagram.

First, in sequence SQ401, the control unit 310 of the client device 110 transmits a request to display a search screen to the server device 100 based on the user's operation or the like.

Next, in sequence SQ402, the control unit 210 of the server device 100 transmits the search screen to the control unit 310 of the client device 110 based on the request from the control unit 310 of the client device 110.

Next, in sequence SQ403, the control unit 310 displays the received search screen on the output unit 340. The search screen includes a region where the user can input an item that the user wishes to search for.

The diagram illustrates an example of the screen 500. The screen 500 includes an input field 510 and an output field 520. The search screen may be the screen 500. In sequence SQ403, the screen 500 is displayed with the input field 510 and the output field 520 in a blank state. The input field 510 is a region where the user inputs a query regarding an item that the user wishes to search for. The output field 520 is a region where search results corresponding to the query input into the input field 510 are output. The output field 520 will be described later.

The user inputs a query (an example of first information) regarding an item that the user wishes to search for into the input field 510. For example, if the user wishes to know information regarding “healthcare using gut microbiome”, the user inputs “healthcare using gut microbiome” as the query into the input field 510.

Next, in sequence SQ404, the control unit 210 of the server device 100 receives the query input into the input field 510 via the client device 110. Here, the control unit 210 can receive any text via the input field 510. That is, the query may be a two-word phrase like “healthcare using gut microbiome”, a single word, or a sentence. Words or phrases input as such queries are also called search terms. In other words, a query, which is an example of first information regarding an item that the user wishes to search for, includes information indicating a search term. Note that it is preferable that the query include information indicating the technical field, as in “healthcare using gut microbiome”, rather than merely “gut microbiome”. When the query includes information indicating the technical field, the item that the user wishes to search for becomes clearer than in the case where the query consists only of a word, and the user can thereby obtain information in a more specific manner. In other words, the query, which is an example of first information, may include information indicating a technical field.

Next, in sequence SQ405, the control unit 210 generates a prompt to be input to a large language model. The prompt includes the query input by the user. The prompt is a request statement that indicates instructions to the large language model, as well as rules and conditions for executing the instructions.

Specifically, the prompt includes an instruction to output multiple keywords evoked from the input query. As the generation step, the control unit 210 generates a prompt corresponding to the input query. The control unit 210 may further generate a prompt that includes the purpose of outputting multiple keywords and the rules for extracting the keywords. By inputting a prompt that explicitly specifies the purpose and rules into the large language model, the control unit 210 can acquire from the large language model multiple keywords that better match the intended purpose. That is, as the generation step, the control unit 210 generates a prompt that instructs the large language model to output multiple keywords for finding documents related to the query.

Here, the control unit 210 may, as the generation step, generate a prompt that instructs the large language model to present multiple keywords from general knowledge related to the query. According to this aspect, it is possible to generate information that is easy to understand even for users who are not researchers specializing in the field.

Furthermore, the control unit 210 may, as the generation step, generate a prompt that instructs the large language model to output the relationships between the plurality of keywords and the query, in particular to classify the relationships between the plurality of keywords and the query. Additionally, the control unit 210 may, as the generation step, generate a prompt that instructs the large language model to output summary information on the multiple keywords related to the query.

Next, in sequence SQ406, the control unit 210 transmits the generated prompt to the large language model in the information processing system 120.

Next, in sequence SQ407, the information processing system 120 receives the prompt from the control unit 210 and inputs the prompt as input data into the large language model. The large language model outputs multiple keywords based on the prompt.

Next, in sequence SQ408, the control unit 210 acquires the multiple keywords output from the large language model. In other words, as the acquisition step, the control unit 210 acquires multiple keywords evoked from the item, input as a query, that the user wishes to search for, via the large language model using a predetermined prompt including the input query (first information).

Next, in sequence SQ409, the control unit 210 generates, based on the multiple keywords and a database storing information on multiple documents, output information in which the item that the user wishes to search for is organized for each theme of the documents. The output information is, based on information on documents related to the keywords, organized for each theme of the documents. For example, by inputting the multiple keywords into the database and analyzing them, the control unit 210 generates output information in which the item, input as a query, that the user wishes to search for is organized.

More specifically, in the processing of sequence SQ409, the control unit 210 inputs the multiple keywords received from the large language model into the document database, and outputs information on documents related to each of the keywords. By using a trained model capable of performing classification and visualization in the document database, the control unit 210 can generate output information in which the item that the user wishes to search for is organized for each theme of the documents. As the trained model, existing learning models such as a Word Embedding model, BERT, or LDA (Latent Dirichlet Allocation) may be used. For example, by using the document database and the trained model described above, the control unit 210 can generate summaries of document information, analyze the generated summaries to identify the themes of the document information, and classify the document information by theme. Furthermore, the control unit 210 can generate output information in which the item that the user wishes to search for is organized based on the document information classified by theme.

Additionally, another example of a method of obtaining output information is described below. In sequence SQ405, when generating a prompt, the control unit 210 may generate a prompt that instructs the large language model to classify the relationships between the multiple keywords and the query, in particular the semantic relationships between the multiple keywords and the query. By generating such a prompt, the control unit 210 is able to obtain information on the relationships between the query and the multiple keywords from the large language model in sequence SQ408. As a result, by matching the relationships between the query and the multiple keywords with document information obtained based on the multiple keywords, the control unit 210 can generate output information in which the item that the user wishes to search for is organized.

Furthermore, in sequence SQ409, the control unit 210 may execute the above methods in combination. By executing the processing of sequence SQ409, the control unit 210 can generate output information that is easy to understand even for users who are not researchers specializing in the field. That is, as the generation step, the control unit 210 generates output information (second information) to be displayed on the client device 110.

Next, in sequence SQ410, the control unit 210 transmits the generated output information to the client device 110 and controls it to be displayed on the client device 110. As the first display control step, the control unit 210 displays, based on the multiple keywords and a database storing information on multiple documents, output information (second information) in which an item, input as a query, that the user wishes to searh for is organized for each theme of the multiple documents.

Next, in sequence SQ411, the control unit 310 displays the output information on a screen. FIG. 5 illustrates an example of this output information displayed in the output field 520. In the example illustrated in FIG. 5, an overview diagram is displayed when “robotics” is input as a query (which may also be referred to as a search term since it is a single word). The overview diagram is an example of a diagram visualizing the relationships among the themes of the documents. That is, the output information (second information) may be a diagram visualizing the relationships among the themes of the documents. Circles respectively represent multiple themes related to technologies. Circles are examples of objects that represent multiple themes related to technologies. The shape of each object is not limited to a circle and may be another shape. The size of each circle indicates the volume of documents related to the corresponding keyword. Furthermore, a line connecting two circles indicates the association between the corresponding technical fields. Moreover, the closer the distance between two circles, the stronger the association between the corresponding technical fields, whereas the farther the distance between two circles, the weaker the association between the corresponding technical fields. Note that, since the overview diagram of FIG. 5 is an overview diagram generated in the case where “robotics” is input as a query, the diagram visualizing the relationships among the themes of the documents can also be regarded as a diagram visualizing the relationships among the technical fields. Additionally, documents related to robotics may also be regarded as technical documents.

According to this aspect, by simply inputting a technology-related query, the user can obtain information in which multiple themes of documents containing keywords related to the query, as well as the associations among the themes, are visualized. In an overview diagram, the volume of documents is represented by the size of a circle, the association is represented by a line connecting two circles, and the degree of association between technical fields is represented by the distance between two circles. Therefore, by referring to the overview diagram, the user can identify which field's documents should be read.

The output information may be a list of documents according to each theme related to a query concerning an item that the user wishes to search for. According to this aspect, the user can check and review a document list for each theme.

In summary, as the first reception step, the control unit 210 of the server device 100 receives a query (first information), input by the user, regarding an item that the user wishes to search for. As the acquisition step, the control unit 210 acquires multiple keywords evoked from the item via a large language model using a predetermined prompt including the input first information. As the first display control step, the control unit 210 displays, based on the multiple keywords and a database storing information on multiple documents, output information (second information) in which the item is organized for each theme of the multiple documents.

According to this aspect, the information processing system 1000 enables a researcher (an example of a user) who wishes to grasp information in a field outside the researcher's own specialty to obtain, by inputting information regarding an item that the researcher wishes to search for via the client device 110, an overview diagram, which is easy to understand even in a field outside the researcher's specialty, or a list of documents (an example of second information) for each theme. That is, when grasping information in a field outside the researcher's specialty, the researcher can identify important themes or documents related to the item that the researcher wishes to search for, without having to indiscriminately read documents of advanced content. As a result, in business development using science and technology, the time required for hypothesis construction and preliminary research can be shortened. Additionally, by using a large language model such as GPT, it is possible to generate keywords that are easy for humans to understand, rather than esoteric keywords, and to use these keywords to display an overview diagram, a list of documents by theme, or other similar information.

### 4.2 Overview of Flow (Part 2)

FIG. 6 is a sequence diagram (part 2) illustrating an example of information processing in the information processing system 1000. The information processing illustrated in FIG. 6 is performed after the information processing illustrated in FIG. 4. Hereinafter, an explanation will be given in accordance with each sequence in this sequence diagram.

First, in sequence SQ601, the control unit 210 determines whether a predetermined operation has been performed on the screen 500 illustrated in FIG. 5. An example of a predetermined operation includes an operation of selecting a circle included in the overview diagram illustrated in FIG. 5. Once a circle is selected on a screen such as that illustrated in FIG. 5, operation information including the fact that the circle has been selected and information regarding the selected circle is transmitted from the client device 110 to the server device 100. Upon receiving such operation information, the control unit 210 determines that a predetermined operation has been performed on the screen 500 illustrated in FIG. 5. As the second reception step, the control unit 210 may receive a selection for one particular theme from among the themes of the documents.

Upon determining that a predetermined operation has been performed, next in sequence SQ602, as the generation step, the control unit 210 generates third information to be displayed on the client device 110. For example, the control unit 210 generates a screen 700 including structured information, as illustrated in FIG. 7 described later. Here, the control unit 210 refers to a document database stored in the storage unit 220 and generates the screen 700 including structured information. The control unit 210 stores, in the document database, information related to multiple keywords acquired from the large language model and information organized for each theme of the documents using the document database based on the keyword-related information, along with multiple pieces of document information, and causes the storage unit 220 to store them.

Next, in sequence SQ603, the control unit 210 transmits the generated screen to the client device 110. That is, as the second display control step, the control unit 210 may display the structured information, which is an example of third information related to the selected particular theme.

Next, in sequence SQ604, the control unit 310 displays the generated screen on the output unit 340.

FIG. 7 is a diagram illustrating an example of the screen 700. The screen 700 includes an output field 710, an output field 730, an output field 760, and a selection field 770. The output field 710 includes structured information. The structured information is information structured based on the field selected by the user from among the fields (examples of the themes of documents) related to documents displayed on the screen 500. In the example illustrated in FIG. 7, the structured information in the case where the field “Computer science” is selected on the screen illustrated in FIG. 5 is illustrated. More specifically, it is indicated that, under the field “Classification”, there are themes such as “Image Recognition”, “SVM”, “Classification”, and “Optimization” at a lower hierarchical level.

In the example illustrated in FIG. 7, a selection object 720, which is an example of an object for selecting the user's level of expertise, is displayed near the structured information. When the user operates the selection object 720 to select the user's level of expertise, the control unit 210 modifies the structured information according to the user's selected level of expertise. In other words, as the second display control step, the control unit 210 displays structured information (third information) corresponding to the user's level of knowledge. In the example illustrated in FIG. 7, the level of expertise is indicated in three stages: 0, 1, and 2; however, the level of expertise is not limited to this. Note that the level of expertise 0 represents the lowest level, and 2 represents the highest level. For example, the control unit 210 generates structured information using more terminology of the specialized field as the level of expertise increases, and generates structured information using words that are easier to understand even for non-experts as the level of expertise decreases. Note that adjusting comprehensibility according to the level of expertise is merely one example. In another example, the control unit 210 may generate structured information with a finer hierarchical structure as the level of expertise increases, and may generate structured information with a coarser hierarchical structure as the level of expertise decreases.

The structured information (third information) may also include statistical information on documents related to a specific theme. The output field 730 includes statistical information on documents in the field selected by the user from among the fields related to the documents displayed on the screen 500. Here, examples of the documents include research papers. Assuming that the documents are research papers, graph 740 represents the number of research papers published annually during a specified period in the selected field. Graph 750 represents the number of research papers published by country in a specified year in the selected field. The number of research papers published annually during a specified period in the selected field, and the number of research papers published by country in a specified year in the selected field, are examples of statistical information.

The output field 760 includes information regarding technical terms in fields related to the field selected by the user from among the fields related to the documents displayed on the screen 500. Technical terms in fields related to the selected field are, as illustrated in FIG. 7, explanatory texts of technical terms in fields such as “Image Recognition”, “SVM”, “Classification”, and “Optimization”, which are related to the selected field “Computer science”, and these texts are output to the output field 760. Note that the control unit 210 may display, in the output field 760, summaries of important papers, such as those with the highest number of citations, in fields related to the selected field. Furthermore, the control unit 210 may display a selection object that allows the user to choose what to display in the output field 760. The control unit 210 may then output the information selected via the selection object to the output field 760. As described above, the information output to the output field 760 includes explanations of technical terms and summaries of papers. In the example illustrated FIG. 7, although only one output field 760 is designated with a reference numeral, the four fields having the same shape are likewise output fields. Note that the number of output fields for displaying explanations of technical terms and summaries of papers is not limited to four.

The selection field 770 is a field for selecting the display language in FIG. 7. When Japanese is selected in the selection field 770, explanations of technical terms and the like are displayed in Japanese. When English is selected in the selection field 770, explanations of technical terms and the like are displayed in English.

That is, the control unit 210 applies control to display an overview diagram in which multiple technology-related fields are clustered and the associations among the technology-related fields are visualized. The control unit 210 further applies control to display structured information, which is information structured based on the field selected by the user from among the fields related to the documents displayed on the screen, according to user operations performed via the screen including the overview diagram.

By simply inputting a technology-related query, the user can obtain information in which multiple themes of documents containing keywords related to the query, as well as the associations among the themes, are visualized. Additionally, by selecting a theme in an overview diagram, the user can obtain structured information that has been structured based on the selected theme.

Furthermore, the control unit 210 applies control to display the screen 700 based on user operations performed via the screen 500 including the overview diagram; the screen 700 includes: structured information based on a theme selected by the user from among the themes related to the documents displayed on the screen 500; statistical information on documents related to the theme selected by the user; and information regarding technical terms related to the theme selected by the user.

By selecting a theme from the overview diagram, the user can simultaneously view the structured information based on the selected theme, statistical information on documents related to the theme, and information regarding technical terms related to the theme on the same screen.

Next, in sequence SQ606, the control unit 210 determines whether a predetermined operation has been performed on the screen 700 illustrated in FIG. 7 or the screen 500 illustrated in FIG. 5. Examples of predetermined operations include operations such as selecting a theme or a technical term corresponding to a theme in the structured information illustrated in FIG. 7, double-tapping an object included in the overview diagram in the screen 500 illustrated in FIG. 5, and so forth. Upon receiving information from the client device 110 indicating that such an operation has been performed, the control unit 210 determines that a predetermined operation has been performed on the screen 700 illustrated in FIG. 7 or the screen 500 illustrated in FIG. 5.

Upon determining that a predetermined operation has been performed, in sequence SQ607, the control unit 210 generates a screen 800 such as that illustrated in FIG. 8 described later.

Next, in sequence SQ608, the control unit 210 transmits the generated screen to the client device 110.

Next, in sequence SQ609, the control unit 310 displays the screen 800 on the output unit 340.

FIG. 8 is a diagram illustrating an example of the screen 800. The screen 800 includes related information on the structured theme indicated by the structured information selected by the user through a user operation, or related information on the technology corresponding to the theme. Alternatively, the screen 800 includes related information on the theme corresponding to an object, selected by the user, included in the overview diagram.

That is, the control unit 210 applies control to display related information on the technology of the structured theme indicated by the structured information based on a predetermined user operation. Related information on the structured information is also an example of third information. The control unit 210 switches the display of related information based on the user's selection of a tab. For example, when a tab 810 is selected, the control unit 210 controls the screen 800 to display, as related information, information regarding startup companies founded using the technology of the selected theme. The information regarding a startup company includes, for example, the company name, access information to the company's website, total funding obtained, number of employees, year of establishment, information on held patents, and overview information on the company. Additionally, for example, when a tab 820 is selected, the control unit 210 controls the screen 800 to display, as related information, information regarding patents published within a predetermined period related to the technology of the selected theme. The predetermined period may be, for example, the most recent three years, or may be preset or settable by the user via the screen. The information regarding a patent includes, for example, the patent number, access information to the patent publication, information on the primary inventor, information on the right holder, expiration date, and overview information on the patent ..

### Modification 1

Modification 1 of the embodiment is described.

In sequence SQ404, the control unit 210 may receive input of a search term and selection of a technical field via the input field 510 on the screen 500. The control unit 210 may display multiple technical fields to be selectable on the screen 500. Examples of technical fields include physics, computer science, mathematics, chemistry, and artificial intelligence. According to this aspect, in sequence SQ405, the control unit 210 is able to generate a prompt corresponding to the selected technical field.

In sequence SQ406, the control unit 210 may input the prompt to the large language model in the information processing system 120 via an API (Application Programming Interface).

The above-described embodiment may be provided in the following modes.
(1) An information processing system comprising: at least one processor, the processor configured to execute the steps comprising: a first reception step of receiving first information, input by a user, regarding an item that the user wishes to search for; an acquisition step of acquiring a plurality of keywords evoked from the item via a large language model using a predetermined prompt including the input first information; and a first display control step of displaying, based on the plurality of keywords and a databse storing information on a plurality of documents, second information in which the item is organized for each theme of the plurality of documents.

According to this aspect, output information in which an item input by the user is organized for each theme of the documents can be displayed.
(2) The information processing system according to (1), wherein: the second information is a diagram visualizing relationships among themes of the plurality of documents.

According to this aspect, output information in which the input item is organized for each theme of the documents and in which the relationships among the themes of the documents are visualized can be displayed.
(3) The information processing system according to (1) or (2), wherein: the second information is a list of documents for each theme related to the item.

According to this aspect, the input item can be organized for each theme of the documents, and a list of documents grouped by theme can be displayed as output information.
(4) The information processing system according to (1) to (3), wherein: the first information includes information indicating a technical field.

According to this aspect, with the use of a query including information indicating a technical field, output information in which items in the technical field are organized can be displayed.
(5) The information processing system according to (1) to (4), wherein: the first information includes information indicating a search term.

According to this aspect, when information containing a word the user wishes to search for is input, output information organized with respect to information containing the input word can be displayed for each theme of the documents.
(6) The information processing system according to (1) to (5), wherein the processor is configured to further execute: a second reception step of receiving a selection for one particular theme from among themes of the plurality of documents; and a second display control step of displaying third information related to the selected particular theme.

According to this aspect, information related to a specific theme can be displayed from output information in which the item input by the user is organized for each theme of the documents.
(7) The information processing system according to (6), wherein: the second display control step displays the third information according to the user's level of knowledge.

According to this aspect, information corresponding to the user's level of knowledge can be displayed.
(8) The information processing system according to (6) or (7), wherein: the third information includes at least one of the following, each related to the particular theme: statistical information on the plurality of documents; explanation of a technical term; summaries of the plurality of documents; information on a startup company; and information on a patent.

According to this aspect, as information related to a particular theme, statistical information on documents, explanations of technical terms, summaries of documents, information on startup companies, and information on patents can be displayed.
(9) An information processing program causing a computer to execute the steps implemented by the information processing system according to (1) to (8).

According to this aspect, output information in which an item input by the user is organized for each theme of the documents can be displayed.
(10) An information processing method comprising: the steps executed by the information processing system according to (1) to (8).

According to this aspect, output information in which an item input by the user is organized for each theme of the documents can be displayed.

Of course, the above are not the only possible implementations. Furthermore, the following aspects may also be adopted.
<1>An information processing system configured to: make a request to a large language model to generate a keyword related to a technical document associated with a search term input via a screen, for each of multiple technology-related fields, the technical document including the search term and field information indicating the multiple fields; acquire the keyword generated by the large language model; and apply control to display overview diagram information in which the multiple technology-related fields are clustered based on information on technical documents related to the keyword, and associations among the multiple technology-related fields are visualized.
<2>The information processing system according to <1>above, wherein, if there is a technical document including the keyword, the information processing system is configured to apply control to display the overview diagram information using information on the technical document including the keyword.
<3>The information processing system according to <1>or <2>above, wherein the information processing system is configured to determine whether there is a technical document including the keyword, and if there is a technical document including the keyword, apply control to display the overview diagram information using information on the technical document including the keyword.
<4>The information processing system according to any one of <1>to <3>above, wherein, based on a user operation via a screen including the overview diagram information, the information processing system is configured to apply control to display structured information, which is information structured based on a field selected by a user from among fields related to technical documents displayed on the screen.
<5>The information processing system according to <4>above, wherein the information processing system is configured to modify the structured information according to a level indicating the user's expertise.
<6>The information processing system according to any one of <1>to <5>above, wherein, based on a user operation via a screen including the overview diagram information, the information processing system is configured to apply control to display statistical information on technical documents in a field selected by a user from among fields related to technical documents displayed on the screen.
<7>The information processing system according to any one of <1>to <6>above, wherein, based on a user operation via a screen including the overview diagram information, the information processing system is configured to apply control to display information regarding a technical term in a field related to a field selected by a user from among fields related to technical documents displayed on the screen.
<8>The information processing system according to any one of <1>to <7>above, wherein, based on a user operation via a screen including the overview diagram information, the information processing system is configured to apply control to display a screen including structured information, which is information structured based on a field selected by a user from among fields related to technical documents displayed on the screen, statistical information on technical documents in the field selected by the user, and information regarding a technical term related to the field selected by the user.
<9>The information processing system according to <4>, <5>, or <8>above, wherein the information processing system is configured to apply control to display related information on technology of the structured field indicated by the structured information based on a predetermined user operation.
<10>The information processing system according to <9>above, wherein the related information is information regarding a startup company founded using the technology of the field.
<11>The information processing system according to <9>above, wherein the related information is information regarding patents published within a predetermined period related to the technology of the field.
<12>The information processing system according to any one of <1>to <11>above, wherein the technical documents are research papers related to technology or patent documents related to technology.
<13>An information processing system configured to: apply control to display overview diagram information in which multiple technology-related fields are clustered and associations among the technology-related fields are visualized; and, based on a user operation via a screen including the overview diagram information, apply control to display structured information, which is information structured based on a field selected by a user from among fields related to technical documents displayed on the screen.
<14>An information processing method executed by an information processing system, comprising: making a request to a large language model to generate a keyword related to a technical document associated with a search term input via a screen, for each of multiple technology-related fields, the technical document including the search term and field information indicating the multiple fields; acquiring the keyword generated by the large language model; and applying control to display overview diagram information in which the multiple technology-related fields are clustered based on information on technical documents related to the keyword, and associations among the multiple technology-related fields are visualized.
<15>An information processing method executed by an information processing system, comprising: applying control to display overview diagram information in which multiple technology-related fields are clustered and associations among the technology-related fields are visualized; and, based on a user operation via a screen including the overview diagram information, applying control to display structured information, which is information structured based on a field selected by a user from among fields related to technical documents displayed on the screen.
<16>A program for causing a computer to implement the information processing system according to any one of <1>to <13>above.

For example, part or all of the processing of the server device 100 described above may be executed by the client device 110.

Finally, although various embodiments of the present invention have been described, these are presented merely as examples and are not intended to limit the scope of the invention. Novel embodiments may be implemented in various other forms, and various omissions, substitutions, and changes can be made without departing from the gist of the invention. Such embodiments and their modifications are included within the scope and gist of the invention, and also within the scope of the invention as defined in the claims and their equivalents.

1. An information processing system comprising:
at least one processor configured to read a program so as to execute:
a first reception step of receiving first information, input by a user, regarding an item that the user wishes to search for;
an acquisition step of acquiring a plurality of keywords evoked from the item via a large language model using a predetermined prompt including the input first information; and
a first display control step of displaying, based on the plurality of keywords and a database storing information on a plurality of documents, second information in which the item is organized for each theme of the plurality of documents.

2. The information processing system according to claim 1, wherein:
the second information is a diagram visualizing relationships among themes of the plurality of documents.

3. The information processing system according to claim 1 wherein:
the second information is a list of documents for each theme related to the item.

4. The information processing system according to claim 1, wherein:
the first information includes information indicating a technical field.

5. The information processing system according to claim 1, wherein:
the first information includes information indicating a search term.

6. The information processing system according to claim 1, wherein the processor is configured to further execute:
a second reception step of receiving a selection for one particular theme from among themes of the plurality of documents; and
a second display control step of displaying third information related to the selected particular theme.

7. The information processing system according to claim 6, wherein:
the second display control step displays the third information according to the user's level of knowledge.

8. The information processing system according to claim 6, wherein:
the third information includes at least one of the following, each related to the particular theme:
statistical information on the plurality of documents;
explanation of a technical term;
summaries of the plurality of documents;
information on a startup company; and
information on a patent.

9. A non-transitory computer-readable memory medium storing a program configured to allow a computer to execute each step of the information processing system according to claim 1.

10. An information processing method comprising:
each step executed by the information processing system according to claim 1.

11. An information processing system comprising:
at least one processor configured to read a program so as to execute:
a first reception step of receiving first information, input by a user, regarding an item that the user wishes to search for;
an acquisition step of acquiring a plurality of keywords evoked from the item via a large language model using a predetermined prompt including the input first information; and
a third display control step of organizing, based on the plurality of keywords and a database storing information on a plurality of documents, the item for each theme of the plurality of documents, generating and displaying third information regarding at least one of themes organized for the each theme, the third information including at least one of the following:
statistical information on the plurality of documents;
explanation of a technical term;
summaries of the plurality of documents;
information on a startup company; and
information on a patent.
